(19) United States
(12) Patent Application Publication
(10) Pub. No.: US 2025/0014343 A1
(43) Pub. Date: Jan. 9, 2025

(54) FRAME-ANOMALY BASED VIDEO SHOT SEGMENTATION USING SELF-SUPERVISED MACHINE LEARNING (ML) MODEL

(71) Applicant: SONY GROUP CORPORATION, TOKYO (JP)

(72) Inventors: SRINIDHI SRINIVASA, BENGALURU (IN); BASAVARAJ MURALI, BENGALURU (IN)

(21) Appl. No.: 18/348,002

(22) Filed: Jul. 6, 2023

(51) Int. Cl. G06V 20/40; G06V 10/774

(52) U.S. Cl. CPC G06V 20/49; G06V 10/774; G06V 20/41

(57) ABSTRACT

An electronic device and a method for implementation for frame-anomaly based video shot segmentation using self-supervised machine learning (ML) model is disclosed. The electronic device receives video data including a set of video frames and creates a synthetic shot dataset including a set of synthetic shots. The electronic device pre-trains an ML model and selects the training data including a first subset of video frames corresponding to a first synthetic shot. The electronic device fine-tunes the pre-trained ML model and selects a test video frame. The electronic device applies the fine-tuned ML model on the test video frame to determine whether the test video frame corresponds to an anomaly. The electronic device labels the first subset of video frames as a single shot. The set of video frames is segmented into a set of shots. The electronic device controls a rendering of the set of shots on a display device.

### FIELD

Various embodiments of the disclosure relate to shot segmentation. More specifically, various embodiments of the disclosure relate to frame-anomaly based video shot segmentation using self-supervised machine learning (ML) model.

### BACKGROUND

Advancements in the field of multi-media technology have led to development of tools for video processing. Typically, video post-processing is a time-consuming process. Though machine learning (ML) models have matured in offering good solutions for video processing, efforts to prepare data for such ML models may be tedious. Currently, ML models for video processing employ supervised learning approach which requires annotated video data, such as video shots. Video shots are building blocks of video processing applications. A video may be segmented into a set of shots manually. Manual shot segmentation of the video may have multiple shortcomings. For example, the manual shot segmentation process of the video may need a significant amount of manual labor. For example, “3600” hours may be required to annotate video shots manually in about “100” movies. Further, the manual shot segmentation process may be prone to human errors and thus, may be inefficient.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for frame-anomaly based video shot segmentation using self-supervised machine learning (ML) model is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for frame-anomaly based video shot segmentation using self-supervised machine learning (ML) model, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary scenario for segmentation of a set of video frames into a set of shots, in accordance with an embodiment of the disclosure.

FIG. 4 is a diagram that illustrates an exemplary processing pipeline for frame-anomaly based video shot segmentation using self-supervised machine learning (ML) model, in accordance with an embodiment of the disclosure.

FIG. 5 is a diagram that illustrates an exemplary scenario for frame-anomaly based video shot segmentation using self-supervised machine learning (ML) model, in accordance with an embodiment of the disclosure.

FIG. 6 is a diagram that illustrates an exemplary scenario for creation of synthetic shot dataset, in accordance with an embodiment of the disclosure.

FIG. 7 is a diagram that illustrates an exemplary scenario for pre-training of the exemplary machine learning (ML) model of FIG. 1, in accordance with an embodiment of the disclosure.

FIG. 8 is a diagram that illustrates an exemplary scenario for fine-tuning of the exemplary machine learning (ML) model of FIG. 1, in accordance with an embodiment of the disclosure.

FIG. 9 is a diagram that illustrates an exemplary scenario for determination of an anomaly score, in accordance with an embodiment of the disclosure.

FIGS. 10A and 10B are diagrams that illustrates exemplary scenarios in which a test video frame corresponds to an anomaly, in accordance with an embodiment of the disclosure.

FIG. 11 is a diagram that illustrates an exemplary scenario in which a test video frame does not correspond to an anomaly, in accordance with an embodiment of the disclosure.

FIG. 12 is a diagram that illustrates an exemplary scenario of an architecture of the exemplary machine learning (ML) model of FIG. 1, in accordance with an embodiment of the disclosure.

FIG. 13 is a flowchart that illustrates operations of an exemplary method for frame-anomaly based video shot segmentation using self-supervised machine learning (ML) model, in accordance with an embodiment of the disclosure.

### DETAILED DESCRIPTION

The following described implementation may be found in an electronic device and method for frame-anomaly based video shot segmentation using self-supervised machine learning (ML) model. Exemplary aspects of the disclosure may provide an electronic device that may receive video data including a set of video frames. The electronic device may create a synthetic shot dataset including a set of synthetic shots based on the received video data. The electronic device may pre-train an ML model based on the created synthetic shot dataset. The electronic device may select, from the received video data, training data including a first subset of video frames corresponding to a first synthetic shot from the set of synthetic shots. The electronic device may fine-tune the pre-trained ML model based on the selected training data. The electronic device may select, from the received video data, a test video frame succeeding the first subset of video frames in the set of video frames. The electronic device may apply the fine-tuned ML model on the selected test video frame. The electronic device may determine whether the selected test video frame corresponds to an anomaly based on the application of the fine-tuned ML model. The electronic device may label the first subset of video frames as a single shot, based on the determination that the select test video frame corresponds to the anomaly. The set of video frames may be segmented into a set of shots based on the labeling of the first subset of video frames as the single shot. The electronic device may control a rendering of the set of shots segmented from the set of video frames on a display device.

Typically, ML models for video processing may employ a supervised learning approach, which may require annotated video data, such as video shots. Conventionally, a video may be segmented into a set of shots manually. Manual shot segmentation of the video may have multiple shortcomings. For example, the manual shot segmentation process of the video may need a significant amount of manual labor. For example, “3600” hours may be required to annotate video shots manually in about “100” movies. Further, the manual shot segmentation process may be prone to human errors and thus, the manual shot segmentation may be inefficient.

In order to address the aforesaid issues, the disclosed electronic device and method may employ frame-anomaly based video shot segmentation using the self-supervised ML model. The ML model of the present disclosure may be self-supervised and may extract every shot of the video data to enable application of state-of-the-art ML model-based solutions for video processing. Thus, the disclosed electronic device may democratize ML based video post-processing methods, where shot segmentation may be a basic requirement and also a major challenge. Therefore, entities that create and manage video contents like movies, web series, streaming shows, and the like, may save hours of manual effort that may be needed for manual shot segmentation of the video data. Further, as the video data is segmented into the set of shots automatically without human intervention, the set of shots may be optimal and more accurate. The disclosed method may be used for movie postproduction, animation creation, independent content creation, video surveillances, and dataset creation for video processing using conventional ML models.

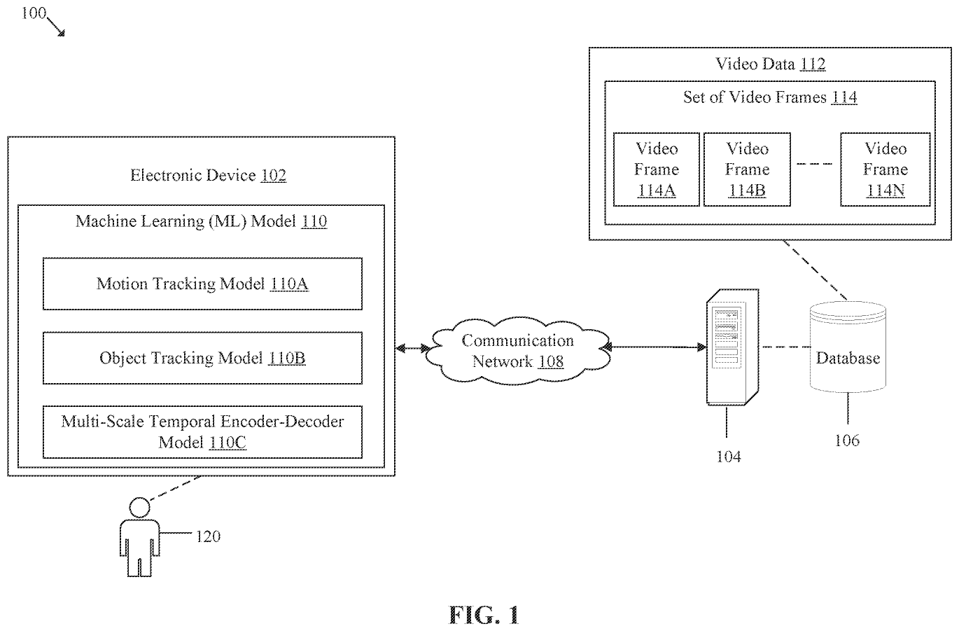

FIG. 1 is a block diagram that illustrates an exemplary network environment for frame-anomaly based video shot segmentation using self-supervised machine learning (ML) model, in accordance with an embodiment of the disclosure. With reference to FIG. 1, there is shown a network environment 100. The network environment 100 may include an electronic device 102, a server 104, a database 106, and a communication network 108. The electronic device 102 may communicate with the server 104 through one or more networks (such as, a communication network 108). The electronic device 102 may include a machine learning (ML) model 110. The ML model 110 may include a motion tracking model 110A, an object tracking model 110B, and a multi-scale temporal encoder-decoder model 110C. The database 106 may store video data 112. The video data 112 may include a set of video frames 114, such a video frame 114A, a video frame 114B, . . . , and a video frame 114N. There is further shown, in FIG. 1, a user 120 who may be associated with and/or who may operate the electronic device 102.

The N number of video frames shown in FIG. 1 are presented merely as an example. The database 106 may include only two or more than N video frames, without deviation from the scope of the disclosure. For the sake of brevity, only N video frames have been shown in FIG. 1. However, in some embodiments, there may be more than N video frames without limiting the scope of the disclosure. In FIG. 1, there is further shown a user 120, who may be associated with or may operate the electronic device 102.

The electronic device 102 may include suitable logic, circuitry, interfaces, and/or code that may be configured to receive the video data 112 including the set of video frames 114. The electronic device 102 may create a synthetic shot dataset including a set of synthetic shots based on the received video data 112. The electronic device 102 may pre-train the ML model 110 based on the created synthetic shot dataset. The electronic device 102 may select training data from the received video data 112. The training data may include a first subset of video frames corresponding to a first synthetic shot from the set of synthetic shots. The electronic device 102 may fine-tune the pre-trained ML model 110 based on the selected training data. The electronic device 102 may select a test video frame from the received video data 112. The test video frame may be succeeding the first subset of video frames in the set of video frames 114. The electronic device 102 may apply the fine-tuned ML model 110 on the selected test video frame. The electronic device 102 may determine whether the selected test video frame corresponds to an anomaly based on the application of the fine-tuned ML model 110. The electronic device 102 may label the first subset of video frames as a single shot, based on the determination that the select test video frame corresponds to the anomaly. The set of video frames 114 may be segmented into a set of shots based on the labeling of the first subset of video frames as the single shot. The electronic device 102 may control a rendering of the set of shots segmented from the set of video frames 114 on a display device.

Examples of the electronic device 102 may include, but are not limited to, a computing device, a smartphone, a cellular phone, a mobile phone, a gaming device, a mainframe machine, a server, a computer workstation, a machine learning device (enabled with or hosting, for example, a computing resource, a memory resource, and a networking resource), and/or a consumer electronic (CE) device.

The server 104 may include suitable logic, circuitry, and interfaces, and/or code that may be configured to receive the video data 112 including the set of video frames 114. The server 104 may create the synthetic shot dataset including the set of synthetic shots based on the received video data 112. The server 104 may pre-train the ML model 110 based on the created synthetic shot dataset. The server 104 may select the training data from the received video data 112. The training data may include the first subset of video frames corresponding to the first synthetic shot from the set of synthetic shots. The server 104 may fine-tune the pre-trained ML model 110 based on the selected training data. The server 104 may select the test video frame from the received video data 112. The test video frame may be succeeding the first subset of video frames in the set of video frames 114. The server 104 may apply the fine-tuned ML model 110 on the selected test video frame. The server 104 may determine whether the selected test video frame corresponds to the anomaly based on the application of the fine-tuned ML model 110. The server 104 may label the first subset of video frames as the single shot, based on the determination that the select test video frame corresponds to the anomaly. The set of video frames 114 may be segmented into the set of shots based on the labeling of the first subset of video frames as the single shot. The server 104 may control the rendering of the set of shots segmented from the set of video frames 114 on the display device.

The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, a machine learning server (enabled with or hosting, for example, a computing resource, a memory resource, and a networking resource), or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store the video data 112 including the set of video frames 114. The database 106 may be derived from data off a relational or non-relational database, or a set of comma-separated values (csv) files in conventional or big-data storage. The database 106 may be stored or cached on a device, such as a server (e.g., the server 104) or the electronic device 102. The device storing the database 106 may be configured to receive a query for the video data 112 from the electronic device 102. In response, the device of the database 106 may be configured to retrieve and provide the queried video data 112 to the electronic device 102, based on the received query.

In some embodiments, the database 106 may be hosted on a plurality of servers stored at the same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the electronic device 102 and the server 104 may communicate with one another. The communication network 108 may be one of a wired connection or a wireless connection. Examples of the communication network 108 may include, but are not limited to, the Internet, a cloud network, Cellular or Wireless Mobile Network (such as Long-Term Evolution and 5th Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The ML model 110 may be a classifier model which may be trained to identify a relationship between inputs, such as, features in a training dataset and output labels. The ML model 110 may be used to segment the set of video frames 114 into the set of shots. The ML model 110 may be defined by its hyper-parameters, for example, number of weights, cost function, input size, number of layers, and the like. The parameters of the ML model 110 may be tuned and weights may be updated so as to move towards a global minima of a cost function for the ML model. After several epochs of the training on the feature information in the training dataset, the ML model 110 may be trained to output a classification result for a set of inputs.

The ML model 110 may include electronic data, which may be implemented as, for example, a software component of an application executable on the electronic device 102. The ML model 110 may rely on libraries, external scripts, or other logic/instructions for execution by a processing device. The ML model 110 may include code and routines configured to enable a computing device, such as the electronic device 102 to perform one or more operations such as, segmentation of the set of video frames 114 into the set of shots. Additionally, or alternatively, the ML model 110 may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 110 may be implemented using a combination of hardware and software.

In an embodiment, the ML model 110 may be a neural network. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset. Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to same or a different same mathematical function.

In training of the neural network, one or more parameters of each node of the neural network may be updated based on whether an output of the final layer for a given input (from the training dataset) matches a correct result based on a loss function for the neural network. The above process may be repeated for same or a different input until a minima of loss function may be achieved, and a training error may be minimized. Several methods for training are known in art, for example, gradient descent, stochastic gradient descent, batch gradient descent, gradient boost, meta-heuristics, and the like.

The motion tracking model 110A may be used to detect a movement of elements between a current data buffer such as, the first subset of video frames and the test video frame. A higher amount of motion between the between the first subset of video frames and the test video frame may imply a higher entropy.

The object tracking model 110B may be used to detect a movement of objects between the first subset of video frames and the test video frame. A higher degree of difference between a location of objects in subsequent frames may imply a higher entropy.

The multi-scale temporal encoder-decoder model 110C may be an ML model that may be used to compare structural information between the first subset of video frames and the test video frame. Lower the structural difference between the first subset of video frames and the test video frame, the lower may be the entropy. The motion tracking model 110A, the object tracking model 110B, and the multi-scale temporal encoder-decoder model 110C may be the ML model similar to the ML model 110. Therefore, the description of the motion tracking model 110A, the object tracking model 110B, and the multi-scale temporal encoder-decoder model 110C is omitted from the disclosure for the sake of brevity.

The video data 112 may correspond to video associated with a movie, a web-based video content, a streaming show, or the like. The video data 112 may include the set of video frames 114. The set of video frames 114 may correspond to a set of still images that may be played sequentially to render the video.

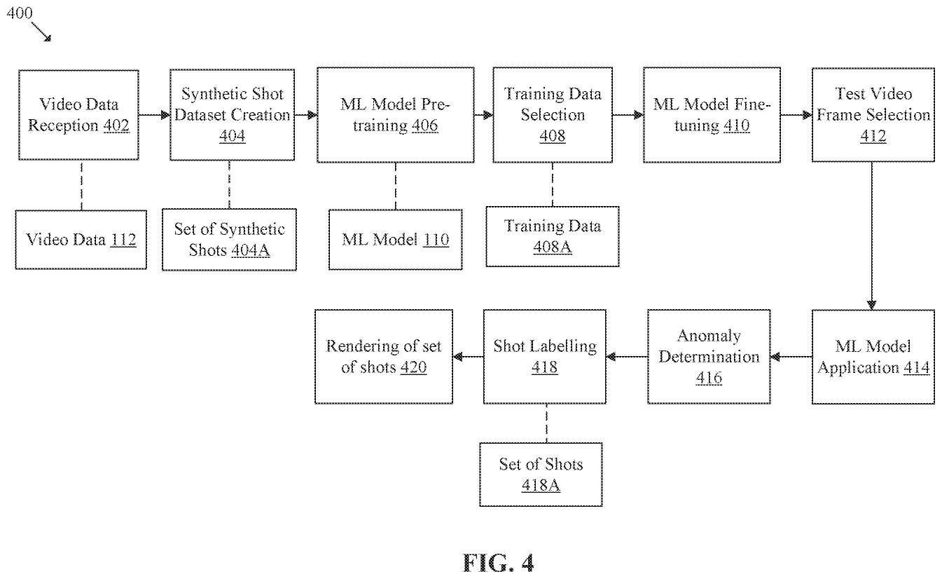

In operation, the electronic device 102 may be configured to receive the video data 112 including the set of video frames 114. For example, a request for the video data 112 may be sent to the database 106. The database 106 may verify the request and provide the video data 112 to the electronic device 102 based on the verification. Details related to the reception of the video data 112 are further provided, for example, in FIG. 4 (at 402).

The electronic device 102 may be configured to create the synthetic shot dataset including the set of synthetic shots based on the received video data 112. Each video frame of the set of video frames 114 may be modified to determine the set of synthetic shots. For example, structures, motion of objects, and types of objects may be modified in each video frame of the set of video frames 114 to determine the set of synthetic shots. Details related to the creation of the synthetic shot dataset are further provided, for example, in FIG. 4 (at 404).

The electronic device 102 may be configured to pre-train the ML model 110 based on the created synthetic shot dataset. Herein, the synthetic shot dataset may be provided to the ML model 110. The ML model 110 may learn a rule to map each synthetic video frame to a synthetic shot based on the created synthetic shot dataset. Details related to the pre-training of the ML model 110 are further provided, for example, in FIG. 4 (at 406).

The electronic device 102 may be configured to select, from the received video data 112, the training data including the first subset of video frames corresponding to the first synthetic shot from the set of synthetic shots. In an example, the first subset of video frames may include a first video frame. The first video frame of the set of video frames 114 may be modified to determine a plurality of synthetic video frames for the first video frame. The plurality of synthetic video frames may correspond to the first synthetic shot. Thus, in such cases, the first video frame may be selected as the first subset of video frames. Details related to the selection of the training data are further provided, for example, in FIG. 4 (at 408).

The electronic device 102 may be configured to fine-tune the pre-trained ML model 110 based on the selected training data. The selected training data may be applied as an input to the pre-trained ML model 110. The pre-trained ML model 110 may learn features associated with the first subset of video frames. Further, the weights associated with the pre-trained ML model 110 may be tuned based on the learnt features. Details related to the selection of the fine-tuning of the pre-trained ML model 110 are further provided, for example, in FIG. 4 (at 410).

The electronic device 102 may be configured to select, from the received video data 112, the test video frame succeeding the first subset of video frames in the set of video frames 114. The test video frame may be a video frame that may be immediately after the received video data 112 in the set of video frames 114. Details related to the selection of the test video frame are further provided, for example, in FIG. 4 (at 412).

The electronic device 102 may be configured to apply the fine-tuned ML model 110 on the selected test video frame. That is, the test video frame, for example, the video frame 114B may be provided as an input to the fine-tuned ML model 110. Details related to the application of the fine-tuned ML model are further provided, for example, in FIG. 4 (at 414).

The electronic device 102 may be configured to determine whether the selected test video frame corresponds to the anomaly based on the application of the fine-tuned ML model 110. Upon application of the fine-tuned ML model 110 on the selected test video frame, the fine-tuned ML model 110 may determine features associated with the test video frame, for example, the video frame 114B. Further, the determined features associated with the test video frame (for example, the video frame 114B) may be compared with the features associated with the first subset of video frames (for example, the video frame 114A) to determine whether selected test video frame corresponds to the anomaly. Details related to the anomaly determination are further provided, for example, in FIG. 4 (at 416).

The electronic device 102 may be configured to label the first subset of video frames as a single shot, based on the determination that the select test video frame corresponds to the anomaly. The set of video frames 114 may be segmented into the set of shots based on the labeling of the first subset of video frames as the single shot. In case the determined features associated with the test video frame do not match with the features associated with the first subset of video frames to at least the pre-defined extent, then the selected test video frame may correspond to the anomaly. Therefore, in such case, the first subset of video frames may correspond to the single shot. Details related to the labelling of the shots are further provided, for example, in FIG. 4 (at 418).

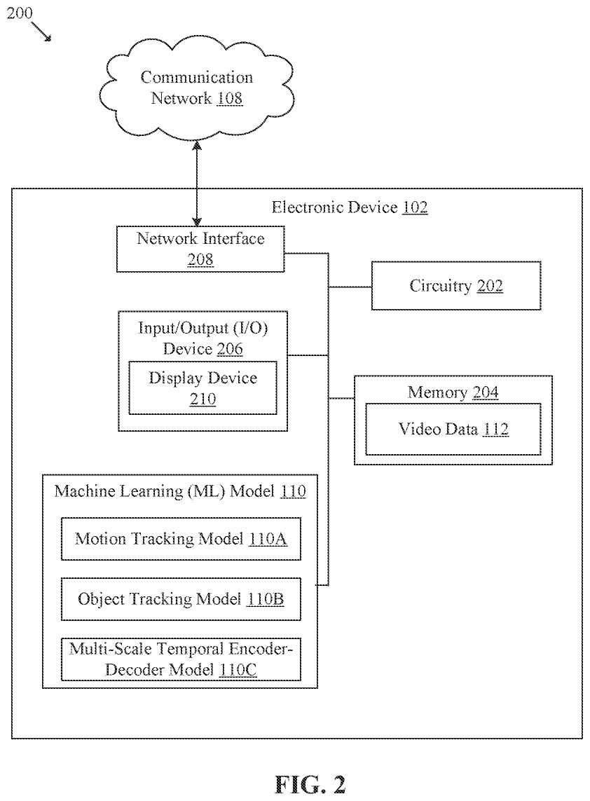

The electronic device 102 may be configured to control the rendering of the set of shots segmented from the set of video frames 114 on a display device (such as, a display device 210 of FIG. 2). The set of shot may be displayed on the display device. The user 120 may then use the rendered set of shot for video processing applications. For example, the rendered set of shot may be applied to conventional ML models for video post-processing. Details related to the rendering of the set of shots are further provided, for example, in FIG. 4 (at 420).

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the exemplary electronic device 102. The electronic device 102 may include circuitry 202, a memory 204, an input/output (I/O) device 206, a network interface 208, and the ML model 110. The ML model 110 may include the motion tracking model 110A, the object tracking model 110B, and the multi-scale temporal encoder-decoder model 110C. The memory 204 may store the video data 112. The input/output (I/O) device 206 may include a display device 210.

The circuitry 202 may include suitable logic, circuitry, and/or interfaces that may be configured to execute program instructions associated with different operations to be executed by the electronic device 102. The operations may include video data reception, synthetic shot dataset creation, ML model pre-training, training data selection, ML model fine-tuning, test video frame selection, ML model application, anomaly determination, shot labelling, and rendering control. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may be configured to execute the different operations of the circuitry 202 (and/or the electronic device 102). The memory 204 may be further configured to store the video data 112. In an embodiment, the ML model 110 may also be stored in the memory 204. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a first user input indicative of a request for shot segmentation of the video data 112. The I/O device 206 may be further configured to display or render the set of shots. The I/O device 206 may include the display device 210. Examples of the I/O device 206 may include, but are not limited to, a display (e.g., a touch screen), a keyboard, a mouse, a joystick, a microphone, or a speaker. Examples of the I/O device 206 may further include braille I/O devices, such as, braille keyboards and braille readers.

The network interface 208 may include suitable logic, circuitry, interfaces, and/or code that may be configured to facilitate communication between the electronic device 102 and the server 104, via the communication network 108. The network interface 208 may be implemented by use of various known technologies to support wired or wireless communication of the electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display or render the set of shots segmented from the set of video frames 114. The display device 210 may be a touch screen which may enable a user (e.g., the user 120) to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for privacy preserving splitting of neural network models for prediction across multiple devices are described further, for example, in FIG. 4.

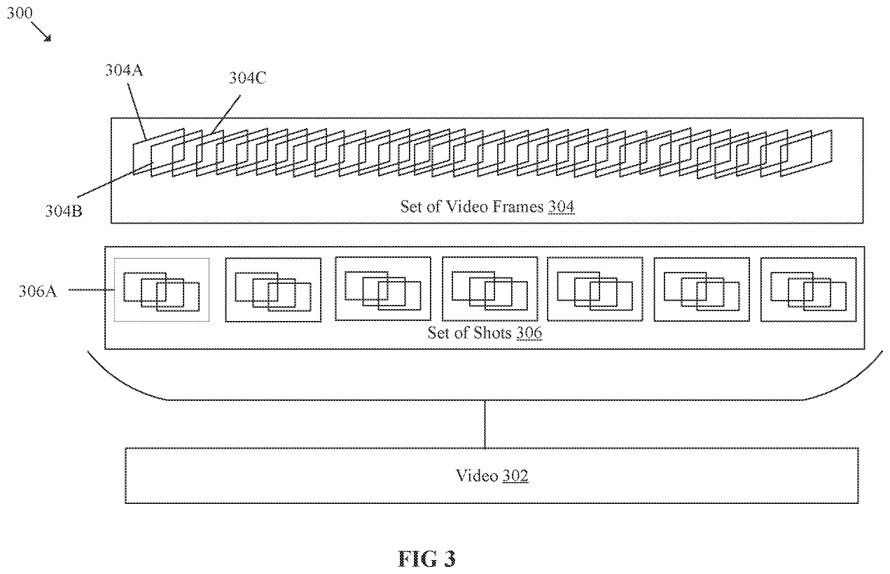

FIG. 3 is a diagram that illustrates an exemplary scenario for segmentation of a set of video frames into a set of shots, in accordance with an embodiment of the disclosure. FIG. 3 is described in conjunction with elements from FIG. 1 and FIG. 2. With reference to FIG. 3, there is shown an exemplary scenario 300. The scenario 300 includes a video 302, a set of video frames 304, (for example, a video frame 304A, a video frame 304B, and a video frame 304C), and a set of shots 306 (for example, a shot 306A). A set of operations associated with the scenario 300 is described herein.

In the scenario 300, the video 302 may include the set of video frames 304 that may be captured and/or played in a sequence during a certain time duration. Each video frame for example, the video frame 304A of the set of video frames 304 may be a still image. The set of video frames 304 may be segmented into the set of shots 306. For example, the video frame 304A, the video frame 304B, and the video frame 304C may correspond to the shot 306A. Details related to the segmentation of the set of video frames into the set of shots are further provided, for example, in FIG. 4

It should be noted that scenario 300 of FIG. 3 is for exemplary purposes and should not be construed to limit the scope of the disclosure.

FIG. 4 is a diagram that illustrates an exemplary processing pipeline for frame-anomaly based video shot segmentation using self-supervised machine learning (ML) model, in accordance with an embodiment of the disclosure. FIG. 4 is explained in conjunction with elements from FIG. 1, FIG. 2, and FIG. 3. With reference to FIG. 4, there is shown, an exemplary processing pipeline 400 that illustrates exemplary operations from 402 to 420 for implementation frame-anomaly based video shot segmentation using self-supervised ML model. The exemplary operations 402 to 420 may be executed by any computing system, for example, by the electronic device 102 of FIG. 1 or by the circuitry 202 of FIG. 2. FIG. 4 further includes the video data 112, a set of synthetic shots 404A, the ML model 110, training data 408A, and a set of shots 418A.

At 402, an operation of the video data reception may be executed. The circuitry 202 may be configured to receive the video data 112 including the set of video frames 114. The video data 112 may be include information associated with audio-visual content of the video (for example, the video 302). Herein, the video may be a pre-recorded video, or a live video. It may be appreciated that in order to create the video 302, an imaging setup may capture still images such as, the set of video frames 114. Each frame may be played in a sequence over a time duration.

In an embodiment, the video data 112 may be received from a temporally weighted data buffer. The temporally weighted data buffer may be a memory space that may be used for storing data, such as the video data 112 temporarily. For example, the imaging setup may capture still images such as, the set of video frames 114. The temporally weighted data buffer may store the video data 112 including the set of video frames 114. The video data 112 may be then transferred from the temporally weighted data buffer to the electronic device 102. In certain cases, the memory 204 may include the temporally weighted data buffer. In other cases, the temporally weighted data buffer may be associated with a device external to the electronic device 102.

In an embodiment, the received video data may include at least one of weight information or morphing information, associated with each video frame of the set of video frames 114. In some cases, each video frame of the set of video frames 114 may be associated with a weight. The weight information may provide information of a value of the weight associated with each video frame of the set of video frames 114. The morphing information may provide information associated with a morphing of the set of video frames 114. It may be appreciated that the morphing may be an effect that may transition an object or a shape of an object from one type to another seamlessly.

At 404, an operation of the synthetic shot dataset creation may be executed. The circuitry 202 may be configured to create the synthetic shot dataset including the set of synthetic shots 404A based on the received video data 112. Each video frame of the set of video frames 114 may be modified to determine a plurality of synthetic video frames for the corresponding video frame. The plurality of synthetic video frames may correspond to one shot.

In an embodiment, the synthetic shot dataset may be based on synthetic data creation information including at least one of information about inpainting information associated with white noise of objects, artificial motion information, object detection pre-training information, or a structural information encoding, associated with each video frame of the set of video frames 114.

In an embodiment, the inpainting information associated with the white noise of objects may provide a degree of the white noise and a type of the white noise that may be introduced in objects of each video frame of the set of video frames 114. In an example, the inpainting information may state that a degree of the white noise may be “x” and a type of the white noise may be “random”. Herein, white pixels may be randomly introduced to one or more objects of the video frame 114A based on a maximum of an “x” degree, in order to generate a plurality of synthetic video frames associated with the video frame 114A. The plurality of synthetic video frames associated with the video frame 114A may correspond to a first synthetic shot. Similarly, the synthetic shot associated with each video frame of the set of video frames 114 other than the video frame 114A may be generated.

The artificial motion information may include details related to a degree and a type of artificial motion that may be introduced to elements of each video frame of the set of video frames 114. In an example, the artificial motion information may state that a degree of the artificial motion may be by “x” centimeters and a type of the artificial motion may be “random”. Herein, elements in the video frame 114A may be randomly moved based on a maximum of an “x” amount, in order to generate a plurality of synthetic video frames associated with the video frame 114A. The plurality of synthetic video frames associated with the video frame 114A may correspond to a first synthetic shot. Similarly, the synthetic shot associated with each video frame of the set of video frames 114 other than the video frame 114A may be generated.

The object detection pre-training information may include details related to the object. In an example, the object detection pre-training information may state that “N” number of objects may be introduced in each video frame. Herein, one or more object from the “N” number of objects may be introduced in the video frame 114A to create the plurality of synthetic video frames associated with the video frame 114A. The plurality of synthetic video frames associated with the video frame 114A may correspond to the first synthetic shot. It may be noted that random objects may be introduced in the first synthetic shot. Further, objects may not be introduced manually, Also, in some cases, objects available in an original video frame such as the video frame 114A may be sufficient. In an embodiment, an object detector model may be pre-trained on public datasets that may encompass common objects that may be present in natural scenes. In another embodiment, the object detector model may be trained on custom datasets. The trained object detector model may be employed to detect objects in the video frame 114A. Typically, an off-the-shelf object detector may be powerful enough to detect at least few object categories in natural videos and images. However, in situations where the object detector model is unable to detect a new object, an object tracking model may be employed for tracking of similar new objects.

The structural information encoding may include details related to changes in structure that may be introduced in each video frame of the set of video frames 114. In an example, the structural information encoding may provide a degree and a type of structural encoding that may be introduced to each video frame of the set of video frames 114 to determine the synthetic shot dataset.

At 406, an operation of pre-training of the ML model may be executed. The circuitry 202 may be configured to pre-train the ML model 110 based on the created synthetic shot dataset. Herein, the synthetic shot dataset may be provided to the ML model 110. The ML model 110 may learn a set of rules to map the plurality of synthetic video frames associated with the video frame 114A to a synthetic shot. Similarly, the ML model 110 may learn a set of rules to map the plurality of synthetic video frames associated with each video frame of the set of video frames 114 to the corresponding synthetic shot.

In an embodiment, the pre-training of the ML model 110 may be based on the synthetic data creation information. The synthetic data creation information may include at least one of the information about inpainting information associated with white noise of objects, the artificial motion information, the object detection pre-training information, or the structural information encoding, associated with each video frame of the set of video frames 114. In an example, the synthetic data creation information may include the artificial motion information. The artificial motion information may state that the degree of the artificial motion may be by “y” centimeters and the type of the artificial motion may be “random”. The artificial motion may be introduced for different objects in each video frame of the set of video frames 114 to obtain the set of synthetic shots 404A. The pre-training of the ML model 110 may be based on the artificial motion information. Herein, the ML model 110 may learn that in case the artificial random motion of “y” centimeters is prevalent between two consecutive video frames then the two consecutive video frames may be classified as one shot.

In an embodiment, the ML model 110 may include the motion tracking model 110A, the object tracking model 110B, or the multi-scale temporal encoder-decoder model 110C. The motion tracking model 110A may track a motion of each element across the set of video frames 114. The object tracking model 110B may track a movement of each object across the set of video frames 114. The multi-scale temporal encoder-decoder model 110C may generate structural information associated with each video frame. Alternatively, the multi-scale temporal encoder-decoder model 110C may generate textual information associated with the video data 112. In an embodiment, the multi-scale temporal encoder-decoder model 110C may generate a sentence describing each video frame. In another embodiment, the multi-scale temporal encoder-decoder model 110C may be used to generate closed captioning for the video.

In an embodiment, the ML model 110 may correspond to a multi-head multi-model system. The ML model 110 may include multiple models such as, the motion tracking model 110A, the object tracking model 110B, or the multi-scale temporal encoder-decoder model 110C. Each model may correspond to a head. Therefore, the ML model 110 may be multi-head. Further, each of the motion tracking model 110A, the object tracking model 110B, or the multi-scale temporal encoder-decoder model 110C may be used based on a scenario. That is, the motion tracking model 110A, the object tracking model 110B, or the multi-scale temporal encoder-decoder model 110C may or may not be used together for each video frame. In an example, a video frame may not include an object. Therefore, in such a situation, only the multi-scale temporal encoder-decoder model 110C may be applied on the aforesaid video frame. Thus, the ML model 110 may be multi-head multi-model system.

At 408, an operation of training data selection may be executed. The circuitry 202 may be configured to select, from the received video data 112, the training data 408A including the first subset of video frames corresponding to the first synthetic shot from the set of synthetic shots 404A. In an example, the first subset of video frames may include a first video frame. The first video frame of the set of video frames 114 may be modified to determine a plurality of synthetic video frames for the first video frame. The plurality of synthetic video frames may correspond to the first synthetic shot. Thus, in such cases, the first video frame may be selected as the first subset of video frames. In another example, a subset of “5” video frames of the set of video frames 114 may be modified to determine the plurality of synthetic video frames for the subset of “5” video frames. The plurality of synthetic video frames may correspond to the first synthetic shot. Thus, in such cases, the subset of “5” video frames may be selected as the first subset of video frames.

At 410, an operation of fine-tuning the pre-trained ML model may be executed. The circuitry 202 may be configured to fine-tune the pre-trained ML model 110 based on the selected training data 408A. The selected training data 408A may be applied as an input to the pre-trained ML model 110. The pre-trained ML model 110 may learn features associated with the first subset of video frames. Further, the weights associated with the pre-trained ML model 110 may tuned based on the learnt features. In an example, the first subset of video frames may be the first video frame. It may be appreciated that the first video frame may be an image. The pre-trained ML model 110 may learn the features associated with the image.

In an embodiment, the fine-tuning of the ML model 110 may be based on the synthetic data creation information. The synthetic data creation information may include at least one of the information about inpainting information associated with white noise of objects, the artificial motion information, the object detection pre-training information, or the structural information encoding, associated with each video frame of the set of video frames 114. In an example, the synthetic data creation information may include the artificial motion information that may state that random artificial motions based on a maximum of “y” centimeters may have been introduced to each video frame of the set of video frames 114 to obtain the set of synthetic shots 404A. The fine-tuning of the ML model 110 may be based on the artificial motion information associated with the training data 408A. Herein, the fine-tuning of the ML model 110 may tune parameters of the pre-trained ML model 110 such that in case the artificial random motion of “x” centimeters is prevalent between two consecutive video frames then the two consecutive video frames may be classified as one shot.

At 412, an operation of test video frame selection may be executed. The circuitry 202 may be configured to select, from the received video data 112, the test video frame succeeding the first subset of video frames in the set of video frames 114. In an example, the, the first subset of video frames may be the video frame 114A. Herein, the video frame succeeding the video frame 114A in the set of video frames 114 may be selected as the test video frame. For example, the video frame 114B (which may succeed the video frame 114A in the set of video frames 114) may be selected as the test video frame.

At 414, an operation of fine-tuned ML model application may be executed. The circuitry 202 may be configured to apply the fine-tuned ML model 110 on the selected test video frame. That is, the test video frame, for example, the video frame 114B, may be provided as an input to the fine-tuned ML model 110. The fine-tuned ML model 110 may be applied on the test video frame (e.g., the video frame 114B) to determine whether or not the test video frame corresponds to an anomaly.

At 416, an operation of anomaly determination may be executed. The circuitry 202 may be configured to determine whether the selected test video frame corresponds to the anomaly based on the application of the fine-tuned ML model 110. Upon application of the fine-tuned ML model 110 on the selected test video frame, the fine-tuned ML model 110 may determine features associated with the test video frame, for example, the video frame 114B. Further, the determined features associated with the test video frame, for example, the video frame 114B, may be compared with the features associated with the first subset of video frames, for example, the video frame 114A. In case the determined features associated with the test video frame match with the features associated with the first subset of video frames to at least a pre-defined extent, then the selected test video frame may not correspond to an anomaly. In case the determined features associated with the test video frame do not match with the features associated with the first subset of video frames to the pre-defined extent, then the selected test video frame may correspond to an anomaly.

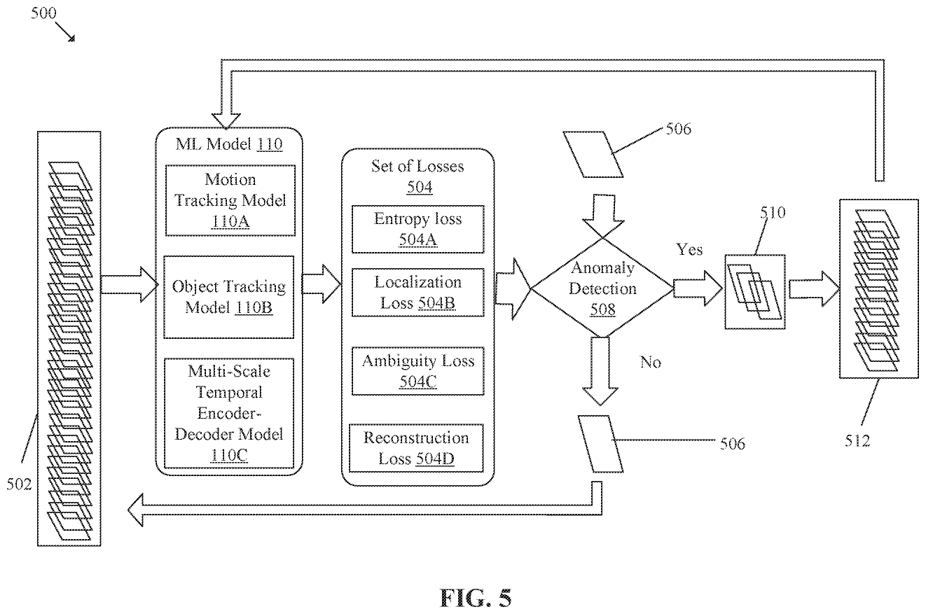

In an embodiment, the circuitry 202 may be configured to determine an anomaly score associated with the test video frame based on the application of the fine-tuned ML model 110. The determination of whether the test video frame corresponds to the anomaly is further based on the determination of the anomaly score associated with the test video frame. The anomaly score may be a score that may indicate how close the features associated with the selected test video frame may be with the features associated with the first subset of video frames. In an embodiment, the circuitry 202 may be configured to determine a set of losses such as, an entropy loss, a localization loss, an ambiguity loss, and a reconstruction loss associated with the test video frame. Thereafter, based on the determined set of losses, the circuitry 202 may be configured to determine the anomaly score associated with the test video frame. The determined anomaly score associated with the test video frame may be compared with a pre-defined anomaly score (e.g., 15% or 0.15). In case, the determined anomaly score is higher than the pre-defined anomaly score, then the selected test video frame may correspond to the anomaly. Details related to the set of losses are further provided, for example, in FIG. 5.

At 418, an operation of shot labelling may be executed. The circuitry 202 may be configured to label the first subset of video frames as a single shot, based on the determination that the select test video frame corresponds to the anomaly. The set of video frames 114 may be segmented into the set of shots 418A based on the labeling of the first subset of video frames as the single shot. In case the determined features associated with the test video frame do not match with the features associated with the first subset of video frames to at least the pre-defined extent, then the selected test video frame may correspond to the anomaly. Therefore, in case the selected test video frame corresponds to the anomaly, then the first subset of video frames may be the single shot. Similarly, the set of video frames 114 may be segmented into the set of shots 418A.

In an embodiment, the circuitry 202 may be further configured to control a storage of the labeled first subset of video frames as the single shot, based on the determination that the selected test video frame corresponds to the anomaly. Herein, the circuitry 202 may control the store the labeled first subset of video frames as the single shot in the database 106. Thereafter, the execution of operations of the processing pipeline 400 may move to the operation 408 and the training data may be selected as a subset of video frames other than the first subset of video frames from the set of video frames 114.

In an embodiment, the circuitry 202 may be further configured to update the selected training data 408A to include the selected test video frame, based on the test video frame not corresponding to the anomaly. The selected test video frame may not correspond to the anomaly when the determined features associated with the test video frame match with the features associated with the first subset of video frames to at least the pre-defined extent. Therefore, in such cases, the selected test video frame may be in a same shot as the selected training data 408A. Thus, the selected test video frame may be added to the selected training data 408A. The execution of the operations of the processing pipeline 400 may then move to the operation 412.

At 420, an operation of rendering of a set of shots may be executed. The circuitry 202 may be configured to control the rendering of the set of shots 418A segmented from the set of video frames 114 on the display device 210. A video editor such as, the user 120, may then make decisions associated with processing of the video data 112 based on the rendered set of shots 418A. For example, one or more shots of the set of shots 418A may edited to include a plurality of visual effects.

The ML model 110 of the present disclosure may receive input based on a feed-back associated with labelling of the first subset of video frames as the single shot. Thus, the ML model 110 may be self-supervised and may extract every shot of the video data 112 to enable application of state-of-the-art ML solutions for video processing. Thus, the disclosed electronic device 102 may democratize ML based video post-processing methods, where shot segmentation may be a basic requirement and also a major challenge. Therefore, entities that create and manage video contents like movies, web series, streaming shows, and the like, may save a significant number of hours of human efforts that may be needed for shot segmentation of the video data including manual tagging of video frames. The ML model 110 of the present disclosure may provide an automatic extraction of coherent frames for application of other conventional ML solutions, which may otherwise require a large number of tagged or labeled video frame data. Further, as the video data 112 is segmented into the set of shots 418A automatically without human intervention, the set of shots 418A may be optimal and free from human errors. The disclosed electronic device 102 may be used for movie postproduction, animation creation, independent content creation, video surveillance, and dataset creation for video processing using conventional ML models.

FIG. 5 is a diagram that illustrates an exemplary scenario for frame-anomaly based video shot segmentation using self-supervised machine learning (ML) model, in accordance with an embodiment of the disclosure. FIG. 5 is described in conjunction with elements from FIG. 1, FIG. 2, FIG. 3, and FIG. 4. With reference to FIG. 5, there is shown an exemplary scenario 500. The scenario 500 may include a first sub-set of video frames 502, the ML model 110, a set of losses 504, a test video frame 506, a shot 510, a second sub-set of video frames 512, and new training data 514 (not shown in FIG. 5). The ML model 110 may include the motion tracking model 110A, the object tracking model 110B, and the multi-scale temporal encoder-decoder model 110C. The set of losses 504 may include an entropy loss 504A, a localization loss 504B, an ambiguity loss 504C, and a reconstruction loss 504D. FIG. 5 further includes an anomaly detection operation 508 that may be executed by any computing system, for example, by the electronic device 102 of FIG. 1 or by the circuitry 202 of FIG. 2. A set of operations associated the with scenario 500 is described herein.

With reference to FIG. 5, for example, the first sub-set of video frames 502 may be an initial training data or a training data at an iteration “k”. The ML model 110 may be fine-tuned based on the initial training data. That is, the fine-tuned ML model 110 may learn features associated with the first sub-set of video frames 502. For example, the features associated with the first sub-set of video frames 502 may include, but are not limited to, colors, textures, object types, number of objects, shape of objects, coordinates of objects, and textures associated with the first sub-set of video frames 502. Based on the application of the ML model 110 on the first sub-set of video frames 502, the set of losses 504 may be determined. The set of losses 504 may include the entropy loss 504A, the localization loss 504B, the ambiguity loss 504C, and the reconstruction loss 504D. The entropy loss 504A may be associated with a movement of elements between each video frame of the first subset of video frames 502 with respect to other video frames of the first subset of video frames 502. The localization loss 504B may be associated with a movement of objects between each frame of the first subset of video frames 502. The ambiguity loss 504C may be associated with ambiguous data. For example, in a vehicle racing game, each frame of the first subset of video frames 502 may include similar vehicles. A first shot may correspond to participants of a team “A” and a second shot may correspond to participants of a team “B”. Objects such as, the vehicles associated with first shot and the second shot may be similar. However, identification numbers (IDs) of each vehicle may be different. The ambiguity loss 504C may take in to account such differences associated with each frame of the first subset of video frames 502. The reconstruction loss 504D may indicate how close a decoder output may be to an encoder input of the multi-scale temporal encoder-decoder model 110C. In an embodiment, the reconstruction loss 504D may be determined based on a mean square error (MSE) between an input video frame applied to the encoder and an output video framed obtained from the decoder of the multi-scale temporal encoder-decoder model 110C.

Upon fine-tuning of the ML model 110, the circuitry 202 may select the test video frame 506. The test video frame 506 may be succeeding the first sub-set of video frames 502 in the set of video frames, for example the set of video frames 114.

At 508, an operation of anomaly detection may be executed. The circuitry 202 apply the fine-tuned ML model 110 on the test video frame 506 to determine whether the test video frame 506 corresponds to an anomaly. In case, the test video frame 506 corresponds to the anomaly, the test video frame 506 may be dissimilar to the first sub-set of video frames 502. Hence, the first sub-set of video frames 502 may be labelled as the shot 510. Thereafter, the new training data 514 (not shown in FIG. 5) may be selected. The new training data 514 may include the second sub-set of video frames 512 that may be different from the first subset of video frames 502. The new training data 514 may be provided as an input to the pre-trained ML model 110 for fine-tuning. However, in case, the test video frame 506 does not correspond to the anomaly, the test video frame 506 may be similar to the first subset of video frames 502. Thus, the test video frame 506 may be added to the first sub-set of video frames 502 to update the initial training data. Thus, the process may be self-fed and the ML model 110 may learn from its own labels. Therefore, the ML model 110 may be self-supervised.

It should be noted that scenario 500 of FIG. 5 is for exemplary purposes and should not be construed to limit the scope of the disclosure.

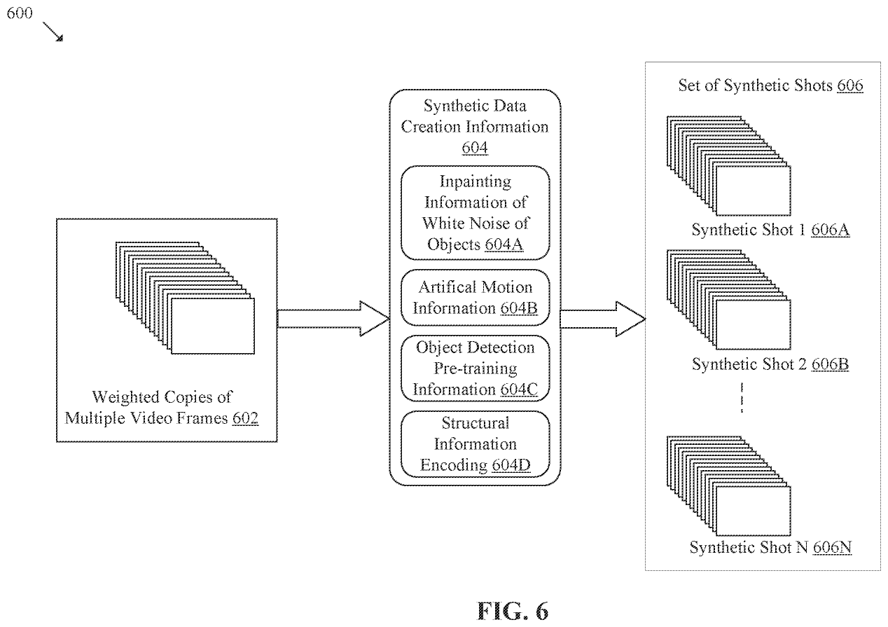

FIG. 6 is a diagram that illustrates an exemplary scenario for creation of synthetic shot dataset, in accordance with an embodiment of the disclosure. FIG. 6 is described in conjunction with elements from FIG. 1, FIG. 2, FIG. 3, FIG. 4, and FIG. 5. With reference to FIG. 6, there is shown an exemplary scenario 600. The scenario 600 may include weighted copies of multiple video frames 602, synthetic data creation information 604, and a set of synthetic shots 606. The synthetic data creation information 604 may include inpainting information of white noise of objects 604A, artificial motion information 604B, object detection pre-training information 604C, structural information encoding 604D. The set of synthetic shots 606 may include “N” number of synthetic shots, such as, a synthetic shot “1” 606A, a synthetic shot “2” 606B, . . . , and a synthetic shot “N” 606N. A set of operations associated the with scenario 600 is described herein.

A person skilled in the art will understand that the N number of synthetic shots is just an example and the scope of the disclosure should not be limited to N synthetic shots. The number of synthetic shots may be two or more than N without departure from the scope of the disclosure.

With reference to FIG. 6, for example, it may be noted that weighted copies of multiple video frames 602 may be created from the set of video frames 114. For example, the set of video frames 114 may include a first video frame, a second video frame, and a third video frame. The weighted copies of multiple video frames 602 for the first video frame may be created by taking “100” copies of the first video frame. The weighted copies of multiple video frames 602 for the second video frame may be created by taking “50” copies of the first video frame and “50” copies of the second video frame. The weighted copies of multiple video frames 602 for the third video frame may be created by taking “33” copies of the first video frame, “33” copies of the second video frame, and “33” copies of the third video frame. In FIG. 6, the weighted copies of multiple video frames 602 may include “N” number of video frames. The circuitry 202 may create the synthetic shot dataset including the set of synthetic shots 606 based on weighted copies of multiple video frames 602 and the synthetic data creation information 604. In order to create the synthetic shot dataset including the set of synthetic shots 606, each video frame of the weighted copies of multiple video frames 602 may be modified based on the inpainting information of white noise of objects 604A, the artificial motion information 604B, the object detection pre-training information 604C, the structural information encoding 604D to create a synthetic shot.

In an example, a first video frame of the weighted copies of multiple video frames 602 may be modified based on an addition of a white noise to the objects of the first video frame using the inpainting information of white noise of objects 604A. The first video frame may be further modified based on an introduction of an artificial motion to the objects in the first video frame based on the artificial motion information 604B to create the synthetic shot “1” 606A. A second video frame of the weighted copies of multiple video frames 602 may be modified based on a change in structures of the first video frame using the structural information encoding 604D to create a first subset of synthetic shot “2” 606B. Further, the second video frame of the weighted copies of multiple video frames 602 may be modified based on a modification of objects of the first video frame using the object detection pre-training information 604C to create a second subset of synthetic shot “2” 606B. The first sub-set of synthetic shot may include the synthetic shot “1” 606A and the second sub-set of synthetic shot may include the synthetic shot “2” 606B. Similarly, each synthetic shot of the set of synthetic shots 606 may be generated. Details related to the inpainting information of white noise of objects 604A, the artificial motion information 604B, the object detection pre-training information 604C, the structural information encoding 604D are further provided for example, in FIG. 4 (at 404).

It should be noted that scenario 600 of FIG. 6 is for exemplary purposes and should not be construed to limit the scope of the disclosure.

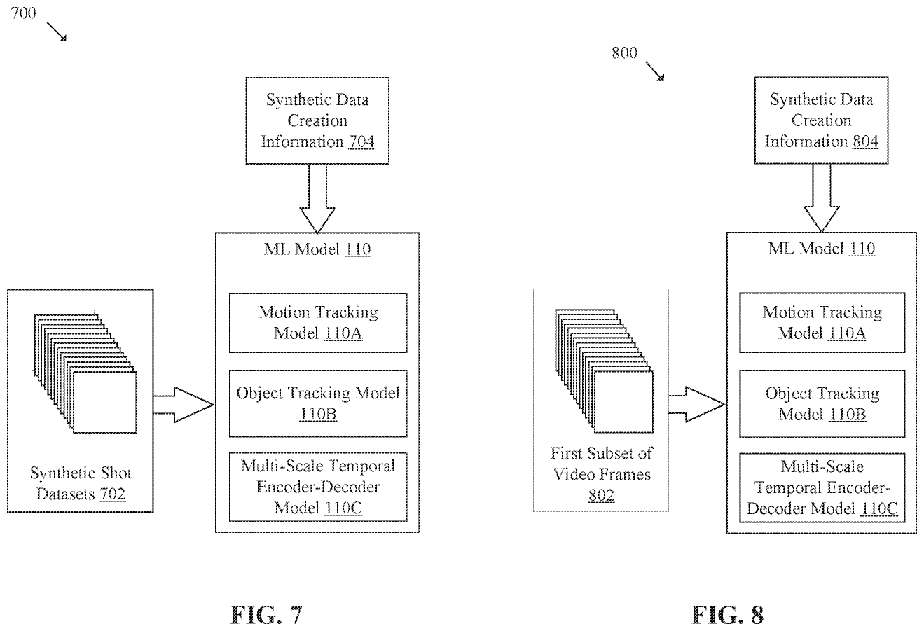

FIG. 7 is a diagram that illustrates an exemplary scenario for pre-training of the exemplary machine learning (ML) model of FIG. 1, in accordance with an embodiment of the disclosure. FIG. 7 is described in conjunction with elements from FIG. 1, FIG. 2, FIG. 3, FIG. 4, FIG. 5, and FIG. 6. With reference to FIG. 7, there is shown an exemplary scenario 700. The scenario 700 may include a synthetic shot dataset 702, synthetic data creation information 704, and the ML model 110. The ML model 110 may include the motion tracking model 110A, the object tracking model 110B, and the multi-scale temporal encoder-decoder model 110C. A set of operations associated the with scenario 700 is described herein.

With reference to FIG. 7, for example, it may be noted that the synthetic shot dataset 702 may be provided as an input to the ML model 110 for pre-training. The ML model 110 may be further fed with the synthetic data creation information 704. Details related to the synthetic data creation information are further provided, for example, in FIG. 4 (at 404). The motion tracking model 110A may be pre-trained to track motions of video frames in the synthetic shot dataset 702. The object tracking model 110B may be pre-trained to track objects in the video frames. The multi-scale temporal encoder-decoder model 110C may be pre-trained to generate textual information associated with each video frame in the synthetic shot dataset 702. For example, the multi-scale temporal encoder-decoder model 110C may be pre-trained generate a sentence or closed-captioned text for each video frame in the synthetic shot dataset 702.

It should be noted that scenario 700 of FIG. 7 is for exemplary purposes and should not be construed to limit the scope of the disclosure.

FIG. 8 is a diagram that illustrates an exemplary scenario for fine-tuning of the exemplary machine learning (ML) model of FIG. 1, in accordance with an embodiment of the disclosure. FIG. 8 is described in conjunction with elements from FIG. 1, FIG. 2, FIG. 3, FIG. 4, FIG. 5, FIG. 6, and FIG. 7. With reference to FIG. 8, there is shown an exemplary scenario 800. The scenario 800 may include a first subset of video frames 802, synthetic data creation information 804, and the ML model 110. The ML model 110 may include the motion tracking model 110A, the object tracking model 110B, and the multi-scale temporal encoder-decoder model 110C. A set of operations associated the with scenario 800 is described herein.

With reference to FIG. 8, for example, the first subset of video frames 802 may include the training data that may be provided as an input to the pre-trained ML model 110. The first subset of video frames 802 may correspond to a first synthetic shot (for example, the synthetic shot “1” 606A) from the set of synthetic shots (for example, the set of synthetic shots 606). The pre-trained ML model 110 may be fine-tuned based on the first subset of video frames 802 and the synthetic data creation information 804. Details related to the synthetic data creation information are further provided, for example, in FIG. 4 (at 404). The pre-trained ML model 110 may learn features associated with the first subset of video frames 802. For example, the pre-trained ML model 110 may learn colors, textures, object types, number of objects, shape of objects, and coordinates of objects associated with the first subset of video frames 802. Details related to fine-tuning of the ML model 110 may be provided, for example, in FIG. 4 (at 410).

It should be noted that scenario 800 of FIG. 8 is for exemplary purposes and should not be construed to limit the scope of the disclosure.

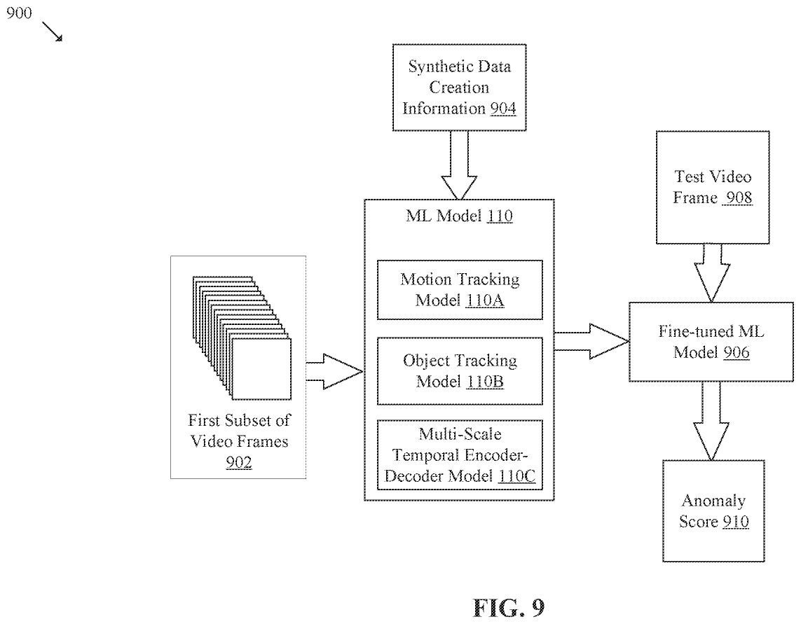

FIG. 9 is a diagram that illustrates an exemplary scenario for determination of an anomaly score, in accordance with an embodiment of the disclosure. FIG. 9 is described in conjunction with elements from FIG. 1, FIG. 2, FIG. 3, FIG. 4, FIG. 5, FIG. 6, FIG. 7, and FIG. 8. With reference to FIG. 9, there is shown an exemplary scenario 900. The scenario 900 may include a first subset of video frames 902, synthetic data creation information 904, the ML model 110, a fine-tuned ML model 906, a test video frame 908, and an anomaly score 910. The ML model 110 may include the motion tracking model 110A, the object tracking model 110B, and the multi-scale temporal encoder-decoder model 110C. A set of operations associated the with scenario 900 is described herein.

With reference to FIG. 9, for example, the first subset of video frames 902 may correspond to the training data. The first subset of video frames 902 may be provided as an input to the pre-trained ML model 110. The pre-trained ML model 110 may be fine-tuned based on the first subset of video frames 902 to obtain the fine-tuned ML model 906. The fine-tuned ML model 906 may have learnt features associated with the first subset of video frames 902. The test video frame 908 may be provided as input to the fine-tuned ML model 906. The fine-tuned ML model 906 may compare features associated with the first subset of video frames 902 and the features associated with the test video frame 908. The anomaly score 910 may be determined based on the comparison. Details related to determination of the anomaly score are further provided, for example, in FIG. 4 (at 416).

It should be noted that scenario 900 of FIG. 9 is for exemplary purposes and should not be construed to limit the scope of the disclosure.

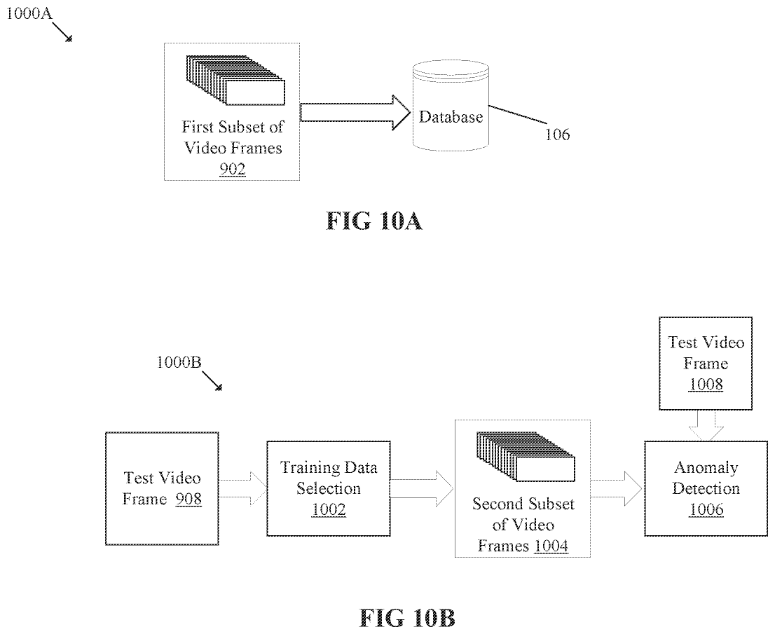

FIGS. 10A and 10B are diagrams that illustrates exemplary scenarios in which a test video frame corresponds to an anomaly, in accordance with an embodiment of the disclosure. FIGS. 10A and 10B are described in conjunction with elements from FIG. 1, FIG. 2, FIG. 3, FIG. 4, FIG. 5, FIG. 6, FIG. 7, FIG. 8, and FIG. 9. With reference to FIGS. 10A and 10B, there are shown exemplary scenarios 1000A and 1000B, respectively. The scenario 1000A may include the first sub-set of video frames 902 and the database 106. The scenario 1000B may include the test video frame 908, a second sub-set of video frames 1004, and a test video frame 1008. The scenario 1000B may further include a training data selection operation 1002 and an anomaly detection operation 1006 that may be executed by any computing system, for example, by the electronic device 102 of FIG. 1 or by the circuitry 202 of FIG. 2. A set of operations associated the with scenario 1000A and the scenario 100B are described herein.

With reference to FIG. 9, for example, the first subset of video frames 902 may correspond to the training data. The anomaly score 910 may be determined based on the comparison of the features associated with the first subset of video frames 902 and the features associated with the test video frame 908. The determined anomaly score 910 may be compared with a pre-defined anomaly score (e.g., 0.15). In case, the determined anomaly score 910 is higher than the pre-defined anomaly score, then the test video frame 908 may correspond to the anomaly. That is, the test video frame 908 may be dissimilar to the first subset of video frames 902. Thus, the first subset of video frames 902 may be labelled as the single shot such as, a first shot. The test video frame 908 may not belong to the first shot to which the first subset of video frames 902 may belong. With reference to FIG. 10A, for example, in case, the test video frame 908 correspond to the anomaly, the circuitry 202 may control the storage of the labelled first subset of video frames 902 in the database 106.

With reference to FIG. 10B, for example, at 1002, an operation of training data selection may be executed. The circuitry 202 may select the training data including the second subset of video frames 1004 from the received video data 112. The second subset of video frames 1004 may include the test video frame 908. The pre-trained ML model 110 may be fine-tuned based on the second subset of video frames 1004. Thereafter, the circuitry 202 may select the test video frame 1008 succeeding the second subset of video frames 1004 in the set of video frames 114. At 1006, the circuitry 202 may determine whether the selected test video frame 1008 corresponds to the anomaly based on the application of the fine-tuned ML model 110. Details related to determination of the anomaly score are further provided, for example, in FIG. 4 (at 416).

It should be noted that scenarios 1000A and 1000B of FIG. 10A and FIG. 10B respectively are for exemplary purposes and should not be construed to limit the scope of the disclosure.

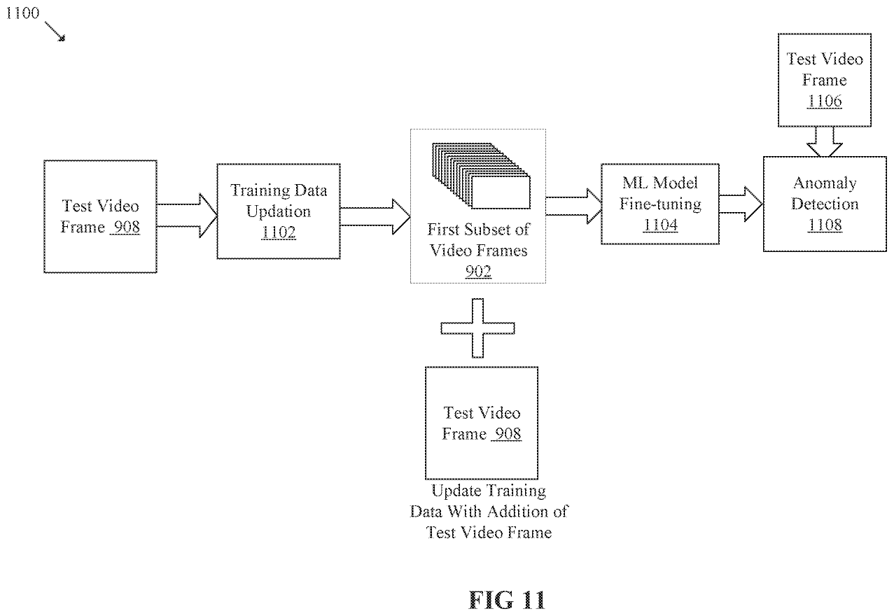

FIG. 11 is a diagram that illustrates an exemplary scenario in which a test video frame does not correspond to an anomaly, in accordance with an embodiment of the disclosure. FIG. 11 is described in conjunction with elements from FIG. 1, FIG. 2, FIG. 3, FIG. 4, FIG. 5, FIG. 6, FIG. 7, FIG. 8, FIG. 9, FIG. 10A, and FIG. 10B. With reference to FIG. 11, there is shown an exemplary scenario 1100. The scenario 1100 may include the first subset of video frames 902, the test video frame 908, and a test video frame 1106. The scenario 1100 may further include a training updating operation 1102, an ML model fine-tuning operation 1104, and an anomaly detection operation 1108 that may be executed by any computing system, for example, by the electronic device 102 of FIG. 1 or by the circuitry 202 of FIG. 2. A set of operations associated the with scenario 1100 is described herein.

With reference to FIG. 11, for example, at 1102, an operation for updating the training data may be executed. The circuitry 202 may execute the training data update operation. In case the test video frame 908 does not correspond to the anomaly, the test video frame 908 may belong to same shot as the shot of the first subset of video frames 902. Hence, in such cases, the test video frame 908 may be added to the first subset of video frames 902 to obtain the updated training data. The pre-trained ML model 110 may be fine-tuned based on the updated training data. Further, the test video frame 1106 may be selected. The selected test video frame 1106 may be succeeding the test video frame 908 in the set of video frames 114.

At 1104, an operation for anomaly detection may be executed. The circuitry 202 may execute the anomaly detection operation. Herein, the fine-tuned ML model 110 may be applied on the selected test video frame 1106 to determine whether the selected test video frame 1106 corresponds to the anomaly. Details related to determination of the anomaly are further provided, for example, in FIG. 4 (at 416).

It should be noted that the scenario 1100 of FIG. 11 is for exemplary purposes and should not be construed to limit the scope of the disclosure.

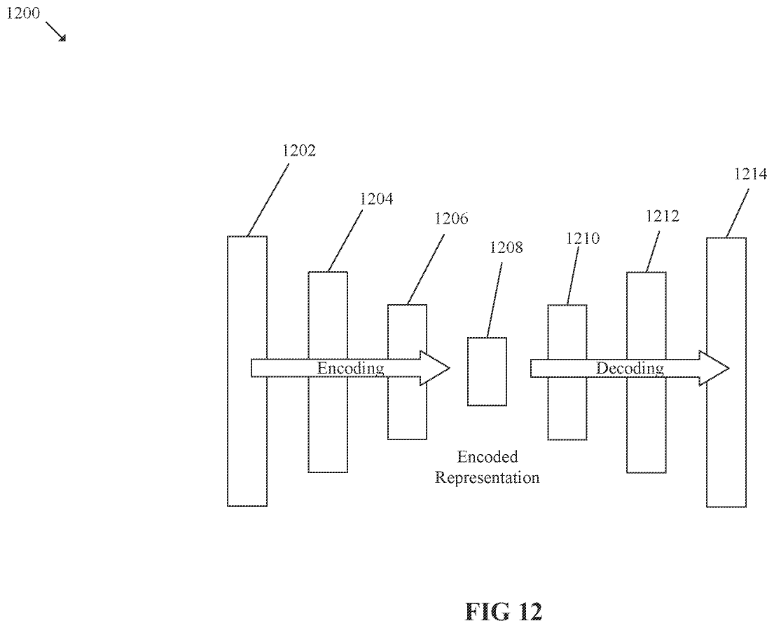

FIG. 12 is a diagram that illustrates an exemplary scenario of an architecture of the exemplary machine learning (ML) model of FIG. 1, in accordance with an embodiment of the disclosure. FIG. 12 is described in conjunction with elements from FIG. 1, FIG. 2, FIG. 3, FIG. 4, FIG. 5, FIG. 6, FIG. 7, FIG. 8, FIG. 9, FIG. 10A, FIG. 10B, and FIG. 11. With reference to FIG. 12, there is shown an exemplary scenario 1200. The scenario 1200 may include a set of layers. The set of layers may include a layer 1202, a layer 1204, a layer 1206, an encoded representation 1208, a layer 1210, a layer 1212, and a layer 1214. A set of operations associated the with scenario 1200 is described herein.

The layer 1202, the layer 1204, the layer 1206, the layer 1210, the layer 1212, and the layer 1214 may be convolutional layers. The layer 1202, the layer 1204, and the layer 1206 may correspond to encoding layers. The layer 1210, the layer 1212, and the layer 1214 may correspond to decoding layers. The layer 1202 may receive a video frame associated with a video as an input. A video rate may have a frame rate of “150” frames per second (150). In an example, a size of the video frame may be “36×64×3×150”, “36×64×3×75”, or “36×64×3×15”. The layer 1202, the layer 1204, and the layer 1206 may encode the video frame. The encoded representation 1208 may be provided as an input to the layer 1210. The layer 1210, the layer 1212, and the layer 1214 may decode the encoded representation 1208. An output of the layer 1214 may be a video frame of size “36×64×3”.

It should be noted that the scenario 1200 of FIG. 12 is for exemplary purposes and should not be construed to limit the scope of the disclosure.

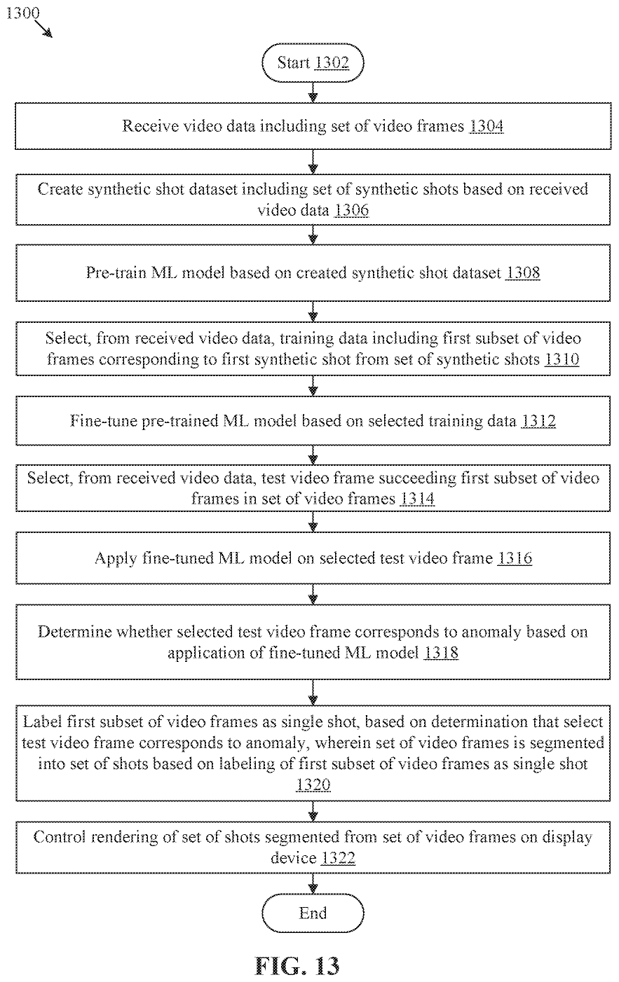

FIG. 13 is a flowchart that illustrates operations of an exemplary method for frame-anomaly based video shot segmentation using self-supervised machine learning (ML) model, in accordance with an embodiment of the disclosure. FIG. 13 is described in conjunction with elements from FIG. 1, FIG. 2, FIG. 3, FIG. 4, FIG. 5, FIG. 6, FIG. 7, FIG. 8, FIG. 9, FIG. 10A, FIG. 10B, FIG. 11, and FIG. 12. With reference to FIG. 13, there is shown a flowchart 1300. The flowchart 1300 may include operations from 1302 to 1322 and may be implemented by the electronic device 102 of FIG. 1 or by the circuitry 202 of FIG. 2. The flowchart 1300 may start at 1302 and proceed to 1304.

At 1304, the video data 112 including the set of video frames 114 may be received. The circuitry 202 may be configured to receive the video data 112 including the set of video frames 114. Details related to the reception of the video data 112 are further described, for example, in FIG. 4 (at 402).

At 1306, the synthetic shot dataset 702 including the set of synthetic shots (for example, the set of synthetic shots 606) may be created based on the received video data 112. The circuitry 202 may be configured to create the synthetic shot dataset 702 including the set of synthetic shots (for example, the set of synthetic shots 606) based on the received video data 112. Details related to the creation of the synthetic shot dataset are further described, for example, in FIG. 4 (at 404).

At 1308, the ML model 110 may be pre-trained based on the created synthetic shot dataset (for example, the set of synthetic shots 606). The circuitry 202 may be configured to pre-train the ML model 110 based on the created synthetic shot dataset (for example, the set of synthetic shots 606). Details related to the pre-training of the ML model 110 are further described, for example, in FIG. 4 (at 406).

At 1310, the training data 408A including the first subset of video frames (for example, the first subset of video frames 802 of FIG. 8) corresponding to the first synthetic shot (for example, the synthetic shot “1” 606A of FIG. 6) from the set of synthetic shots (for example, the set of synthetic shots 606 of FIG. 6) may be selected from the received video data 112. The circuitry 202 may be configured to select the training data 408A including the first subset of video frames (for example, the first subset of video frames 802 of FIG. 8) from the received video data 112. The first subset of video frames (for example, the first subset of video frames 802 of FIG. 8) may correspond to the first synthetic shot (for example, the synthetic shot “1” 606A of FIG. 6) from the set of synthetic shots (for example, the set of synthetic shots 606 of FIG. 6). Details related to the selection of the training data 408A are further described, for example, in FIG. 4 (at 408).

At 1312, the pre-trained ML model 110 may be fine-tuned based on the selected training data 408A. The circuitry 202 may be configured to fine-tune the pre-trained ML model 110 based on the selected training data 408A. Details related to the fine-tuning of the ML model 110 are further described, for example, in FIG. 4 (at 410).

At 1314, the test video frame (for example, the test video frame 908 of FIG. 9) succeeding the first subset of video frames (for example, the first subset of video frames 902 of FIG. 9) in the set of video frames 114 may be selected from the received video data 112. The circuitry 202 may be configured to select the test video frame (for example, the test video frame 908 of FIG. 9) from the received video data 112. The test video frame (for example, the test video frame 908 of FIG. 9) may be succeeding the first subset of video frames (for example, the first subset of video frames 902 of FIG. 9) in the set of video frames 114. Details related to the selection of the test video frame are further described, for example, in FIG. 4 (at 412).

At 1316, the fine-tuned ML model 110 may be applied on the selected test video frame (for example, the test video frame 908 of FIG. 9). The circuitry 202 may be configured to apply the fine-tuned ML model 110 on the selected test video frame (for example, the test video frame 908 of FIG. 9). Details related to the fine-tuning of the ML model 110 are further described, for example, in FIG. 4 (at 414).

At 1318, whether the selected test video frame (for example, the test video frame 908 of FIG. 9) corresponds to the anomaly may be determined based on the application of the fine-tuned ML model 110. The circuitry 202 may be configured to determine whether the selected test video frame (for example, the test video frame 908 of FIG. 9) corresponds to the anomaly based on the application of the fine-tuned ML model 110. Details related to the anomaly determination are further described, for example, in FIG. 4 (at 416).

At 1320, the first subset of video frames (for example, the first subset of video frames 902 of FIG. 9) may be labelled as the single shot, based on the determination that the selected test video frame (for example, the test video frame 908 of FIG. 9) corresponds to the anomaly, wherein the set of video frames 114 may be segmented into the set of shots 418A based on the labeling of the first subset of video frames (for example, the first subset of video frames 902 of FIG. 9) as the single shot. The circuitry 202 may be configured to label the first subset of video frames (for example, the first subset of video frames 902 of FIG. 9) as the single shot, based on the determination that the select test video frame (for example, the test video frame 908 of FIG. 9) corresponds to the anomaly. The set of video frames 114 may be segmented into the set of shots 418A based on the labeling of the first subset of video frames (for example, the first subset of video frames 902 of FIG. 9) as the single shot. Details related to the shot labelling are further described, for example, in FIG. 4 (at 418).

At 1322, the rendering of the set of shots 418A segmented from the set of video frames 114 on the display device 210 may be controlled. The circuitry 202 may be configured to control the rendering of the set of shots 418A segmented from the set of video frames 114 on the display device 210. Details related to the rendering of the set of shots 418A are further described, for example, in FIG. 4 (at 420). Control may pass to end.

Although the flowchart 1300 is illustrated as discrete operations, such as, 1304, 1306, 308, 1310, 1312, 1314, 1316, 1318, 1320, and 1322, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include reception of video data (e.g., the video data 112) including a set of video frames (e.g., the set of video frames 114). The operations may further include creation of a synthetic shot dataset (e.g., the synthetic shot dataset 702) including a set of synthetic shots (for example, the set of synthetic shots 606) based on the received video data 112. The operations may further include pre-training a machine learning (ML) model (e.g., the ML model 110) based on the created synthetic shot dataset (for example, the set of synthetic shots 606). The operations may further include selection of training data (e.g., the training data 408A) including a first subset of video frames (for example, the first subset of video frames 802 of FIG. 8) from the received video data 112. The first subset of video frames (for example, the first subset of video frames 802 of FIG. 8) may correspond to a first synthetic shot (for example, the synthetic shot “1” 606A of FIG. 6) from the set of synthetic shots (for example, the set of synthetic shots 606 of FIG. 6). The operations may further include fine-tuning the pre-trained ML model 110 based on the selected training data 408A. The operations may further include selection of a test video frame (for example, the test video frame 908 of FIG. 9) from the received video data 112. The test video frame (for example, the test video frame 908 of FIG. 9) may be succeeding the first subset of video frames (for example, the first subset of video frames 902 of FIG. 9) in the set of video frames 114. The operations may further include application of the fine-tuned ML model 110 on the selected test video frame (for example, the test video frame 908 of FIG. 9). The operations may further include determination of whether the selected test video frame (for example, the test video frame 908 of FIG. 9) corresponds to an anomaly based on the application of the fine-tuned ML model 110. The operations may further include labeling the first subset of video frames (for example, the first subset of video frames 902 of FIG. 9) as a single shot, based on the determination that the select test video frame (for example, the test video frame 908 of FIG. 9) corresponds to the anomaly. The set of video frames 114 may be segmented into the set of shots (for example, the set of shots 418A) based on the labeling of the first subset of video frames (for example, the first subset of video frames 902 of FIG. 9) as the single shot. The operations may further include controlling the rendering of the set of shots (for example, the set of shots 418A) segmented from the set of video frames 114 on a display device (e.g., the display device 210).

Exemplary aspects of the disclosure may provide an electronic device (such as, the electronic device 102 of FIG. 1) that includes circuitry (such as, the circuitry 202). The circuitry 202 may be configured to receive the video data 112 including the set of video frames 114. The circuitry 202 may be configured to create the synthetic shot dataset (for example, the synthetic shot dataset 702 of FIG. 7) including the set of synthetic shots (for example, the set of synthetic shots 606) based on the received video data 112. The circuitry 202 may be configured to pre-train the ML model 110 based on the created synthetic shot dataset (for example, the set of synthetic shots 606). The circuitry 202 may be configured to the select the training data 408A including the first subset of video frames (for example, the first subset of video frames 802 of FIG. 8) from the received video data 112. The first subset of video frames (for example, the first subset of video frames 802 of FIG. 8) may correspond to the first synthetic shot (for example, the synthetic shot “1” 606A of FIG. 6) from the set of synthetic shots (for example, the set of synthetic shots 606 of FIG. 6). The circuitry 202 may be configured to fine-tune the pre-trained ML model 110 based on the selected training data 408A. The circuitry 202 may be configured to select the test video frame (for example, the test video frame 908 of FIG. 9) from the received video data 112. The test video frame (for example, the test video frame 908 of FIG. 9) may be succeeding the first subset of video frames (for example, the first subset of video frames 902 of FIG. 9) in the set of video frames 114. The circuitry 202 may be configured to apply the fine-tuned ML model 110 on the selected test video frame (for example, the test video frame 908 of FIG. 9). The circuitry 202 may be configured to determine whether the selected test video frame (for example, the test video frame 908 of FIG. 9) corresponds to the anomaly based on the application of the fine-tuned ML model 110. The circuitry 202 may be configured to label the first subset of video frames (for example, the first subset of video frames 902 of FIG. 9) as the single shot, based on the determination that the select test video frame (for example, the test video frame 908 of FIG. 9) corresponds to the anomaly, wherein the set of video frames 114 may be segmented into the set of shots (for example, the set of shots 418A) based on the labeling of the first subset of video frames (for example, the first subset of video frames 902 of FIG. 9) as the single shot. The circuitry 202 may be configured to control the rendering of the set of shots (for example, the set of shots 418A) segmented from the set of video frames 114 on the display device 210.

In an embodiment, the received video data 112 may include at least one of weight information or morphing information, associated with each video frame of the set of video frames 114.

In an embodiment, creation of the synthetic shot dataset (for example, the synthetic shot dataset 702 of FIG. 7) may be based on the synthetic data creation information (for example, the synthetic data creation information 604 of FIG. 6) including at least one of information about inpainting information associated with white noise of objects (for example, the inpainting information of white noise of objects 604A of FIG. 6), artificial motion information (for example, the artificial motion information 604B of FIG. 6), object detection pre-training information (for example, the object detection pre-training information 604C of FIG. 6), or structural information encoding (for example, the structural information encoding 604D of FIG. 6), associated with each video frame of the set of video frames 114

In an embodiment, at least one of the pre-training or the fine-tuning of the ML model 110 may be based on the synthetic data creation information (for example, the synthetic data creation information 604 of FIG. 6).

In an embodiment, the ML model 110 may correspond to at least one of a motion tracking model (e.g., the motion tracking model 110A), an object tracking model (e.g., the object tracking model 110B), or a multi-scale temporal encoder-decoder model (e.g., the multi-scale temporal encoder-decoder model 110C).

In an embodiment, the circuitry 202 may be further configured to determine an anomaly score associated with the test video frame (for example, the selected test video frame 908 of FIG. 9) based on the application of the fine-tuned ML model 110. The determination of whether the test video frame (for example, the selected test video frame 908 of FIG. 9) corresponds to the anomaly may be further based on the determination of the anomaly score associated with the test video frame (for example, the selected test video frame 908 of FIG. 9).

In an embodiment, the circuitry 202 may be further configured to update the selected training data 408A to include the selected test video frame (for example, the selected test video frame 908 of FIG. 9), based on the test video frame (for example, the selected test video frame 908 of FIG. 9) not corresponding to the anomaly.

In an embodiment, the circuitry 202 may be further configured to control the storage of the labeled first subset of video frames (for example, the labeled first subset of video frames 902 of FIG. 9) as the single shot, based on the determination that the selected test video frame (for example, the selected test video frame 908 of FIG. 9) corresponds to the anomaly.

In an embodiment, the video data 112 may be received from the temporally weighted data buffer.

In an embodiment, the ML model 110 may correspond to the multi-head multi-model system.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive video data including a set of video frames;
create a synthetic shot dataset including a set of synthetic shots based on the received video data;
pre-train a machine learning (ML) model based on the created synthetic shot dataset;
select, from the received video data, training data including a first subset of video frames corresponding to a first synthetic shot from the set of synthetic shots;
fine-tune the pre-trained ML model based on the selected training data;
select, from the received video data, a test video frame succeeding the first subset of video frames in the set of video frames;
apply the fine-tuned ML model on the selected test video frame;
determine whether the selected test video frame corresponds to an anomaly based on the application of the fine-tuned ML model;
label the first subset of video frames as a single shot, based on the determination that the select test video frame corresponds to the anomaly, wherein
the set of video frames is segmented into a set of shots based on the labeling of the first subset of video frames as the single shot; and
control a rendering of the set of shots segmented from the set of video frames on a display device.

2. The electronic device according to claim 1, wherein the received video data includes at least one of weight information or morphing information, associated with each video frame of the set of video frames.

3. The electronic device according to claim 1, wherein the creation of the synthetic shot dataset is based on synthetic data creation information including at least one of information about inpainting information associated with white noise of objects, artificial motion information, object detection pre-training information, or a structural information encoding, associated with each video frame of the set of video frames.

4. The electronic device according to claim 3, wherein at least one of the pre-training or the fine-tuning of the ML model is based on the synthetic data creation information.

5. The electronic device according to claim 1, wherein the ML model corresponds to at least one of a motion tracking model, an object tracking model, or a multi-scale temporal encoder-decoder model.

6. The electronic device according to claim 1, wherein the circuitry is further configured to:
determine an anomaly score associated with the test video frame based on the application of the fine-tuned ML model, wherein
the determination of whether the test video frame corresponds to the anomaly is further based on the determination of the anomaly score associated with the test video frame.

7. The electronic device according to claim 1, wherein the circuitry is further configured to update the selected training data to include the selected test video frame, based on the test video frame not corresponding to the anomaly.

8. The electronic device according to claim 1, wherein the circuitry is further configured to control a storage of the labeled first subset of video frames as the single shot, based on the determination that the selected test frame corresponds to the anomaly.

9. The electronic device according to claim 1, wherein the video data is received from a temporally weighted data buffer.

10. The electronic device according to claim 1, wherein the ML model corresponds to a multi-head multi-model system.

11. A method, comprising:
in an electronic device:
receiving video data including a set of video frames;
creating a synthetic shot dataset including a set of synthetic shots based on the received video data;
pre-training a machine learning (ML) model based on the created synthetic shot dataset;
selecting, from the received video data, training data including a first subset of video frames corresponding to a first synthetic shot from the set of synthetic shots;
fine-tuning the pre-trained ML model based on the selected training data;
selecting, from the received video data, a test video frame succeeding the first subset of video frames in the set of video frames;
applying the fine-tuned ML model on the selected test video frame;
determining whether the selected test video frame corresponds to an anomaly based on the application of the fine-tuned ML model;
labelling the first subset of video frames as a single shot, based on the determination that the select test video frame corresponds to the anomaly, wherein
the set of video frames is segmented into a set of shots based on the labeling of the first subset of video frames as the single shot; and
controlling a rendering of the set of shots segmented from the set of video frames on a display device.

12. The method according to claim 11, wherein the received video data includes at least one of weight information or morphing information, associated with each video frame of the set of video frames.

13. The method according to claim 11, wherein the creation of the synthetic shot dataset is based on synthetic data creation information including at least one of information about inpainting information associated with white noise of objects, artificial motion information, object detection pre-training information, or a structural information encoding, associated with each video frame of the set of video frames.

14. The method according to claim 13, wherein at least one of the pre-training or the fine-tuning of the ML model is based on the synthetic data creation information.

15. The method according to claim 11, wherein the ML model corresponds to at least one of a motion tracking model, an object tracking model, or a multi-scale temporal encoder-decoder model.

16. The method according to claim 11, further comprising:
determining an anomaly score associated with the test video frame based on the application of the fine-tuned ML model, wherein
the determination of whether the test video frame corresponds to the anomaly is further based on the determination of the anomaly score associated with the test video frame.

17. The method according to claim 11, further comprising updating the selected training data to include the selected test video frame, based on the test video frame not corresponding to the anomaly.

18. The method according to claim 11, further comprising controlling a storage of the labeled first subset of video frames as the single shot, based on the determination that the selected test frame corresponds to the anomaly.

19. The method according to claim 11, wherein
the video data is received from a temporally weighted data buffer, and
the ML model corresponds to a multi-head multi-model system.

20. A non-transitory computer-readable medium having stored thereon, computer-executable instructions that when executed by an electronic device, causes the electronic device to execute operations, the operations comprising:
receiving video data including a set of video frames;
creating a synthetic shot dataset including a set of synthetic shots based on the received video data;
pre-training a machine learning (ML) model based on the created synthetic shot dataset;
selecting, from the received video data, training data including a first subset of video frames corresponding to a first synthetic shot from the set of synthetic shots;
fine-tuning the pre-trained ML model based on the selected training data;
selecting, from the received video data, a test video frame succeeding the first subset of video frames in the set of video frames;
applying the fine-tuned ML model on the selected test video frame;
determining whether the selected test video frame corresponds to an anomaly based on the application of the fine-tuned ML model;
labelling the first subset of video frames as a single shot, based on the determination that the select test video frame corresponds to the anomaly, wherein
the set of video frames is segmented into a set of shots based on the labeling of the first subset of video frames as the single shot; and
controlling a rendering of the set of shots segmented from the set of video frames on a display device.
